(19) United States
(12) Patent Application Publication
(10) Pub. No.: US 2009/0061816 A1
(43) Pub. Date: Mar. 5, 2009

(54) Network controlled classification of service tariff class

(75) Inventors: Siegfried Ergezinger, Mettmann (DE); Hakan Ekman, Dusseldorf (DE)

Correspondence Address: MICHAELSON & ASSOCIATES, P.O. BOX 8489, RED BANK, NJ, 07701-8489, US

(73) Assignee: Koninklijke KPN N.V., The Hague (NL)

(21) Appl. No.: 11/920,382

(22) PCT Filed: Jun. 7, 2006
(86) PCT No.: PCT/EP2006/005414

§ 371 Date: Nov. 14, 2007

Related U.S. Application Data
(60) Provisional application No. 60/688,016, filed on Jun. 7, 2005.
(60) Provisional application No. 60/717,884, filed on Sep. 16, 2005.
(60) Provisional application No. 60/740,389, filed on Nov. 29, 2005.

(51) Int. Cl. H04M 11/00

(52) U.S. Cl. 455/406

(57) ABSTRACT

The present invention provides a solution to prevent customers from misusing of telecommunication services and to enable measures to charge customers for actual used services in case of misuse. The present invention also provides a solution to offer personalized content services. Hereto a user identity, a user equipment Identity and/or an actual used service type are analyzed and the service tariff class is changed based on the analysis.

### FIELD

The invention relates to a method and a network component for determining a service tariff class. The invention further relates to a telecommunication system comprising the network component for determining a service tariff class.

### BACKGROUND

Usually a network operator wants to charge for chargeable events such as activities utilizing the telecommunications network infrastructure and related services. The telecommunications network infrastructure can comprise several domains that provide services using a certain technology. An example of a domain is a circuit switched domain in which information is transferred in circuit mode (e.g. PSTN, ISDN, GSM [also known as 2G], CDMA). Another example of a domain is a packet switched domain in which data is transferred in packet mode (e.g. GPSR [also known as 2.5G], UMTS [also known as 3G], LAN, WAN, WLAN [also known as WiFi], Internet). Examples of related services are user-to-user communication (e.g. a single call, a data communication session or a short message), user to network communication (e.g. service profile administration), inter-network communication (e.g. transferring calls, signaling, or short messages), and mobility (e.g. roaming or intersystem handover).

In this context charging is the function whereby information related to a chargeable event is formatted and transferred in order to make it possible to determine usage for which the charged party may be billed, taking into account a tariff for the chargeable event. The tariff is a set of parameters defining the network utilization charges for the use of a particular service. The charged party is the user involved in a chargeable event who has to pay parts or the whole charges of the chargeable event, or a third party paying the charges caused by one or all users involved in the chargeable event, or the network operator. Billing is the function whereby call detail records (CDR) are generated by the charging function and transformed into bills requiring payment.

Tariffs for telecommunication services can be linked to specific services in combination with specific user equipment like fixed phones, mobile phones, VoIP phones, PDAs, PCs, notebooks, etcetera. It is common that used services are charged independent of the used network domain. This can be problematic. The following examples show when this can be problematic.

Assume that there is a service (a) charged with a high tariff and a service (b) charged with a low tariff. Both services are accessed using the same domain. A customer can misuse service (b) by actually using service (a) via service (b), while being charged for service (b).

### Examples are

service (a) being VoIP and service (b) being normal internet browsing;
service (a) being open MMS via internet and service (b) being normal internet browsing; and
service (a) having a high VoIP tariff for VoIP via a mobile phone using UMTS and service (b) having a low VoIP tariff for VoIP via a notebook using UMTS.

Principles of charging and billing for the provision of services and services by a 3G-system are described in “3GPP TS 32.200 V5.8.0 (2005-03); Technical Specification 3rd Generation Partnership Project; Technical Specification Group Services and System Aspects; Telecommunication management; Charging management; Charging principles (Release 5)”.

An International Mobile Equipment Identity (IMEI) is used to uniquely identify user equipment. The IMEI code is embedded in the user equipment and can be queried by the network operator. IMEI codes can be stored in a database, the Equipment Identity Register (EIR), in an observed IMEI ticket. The observed IMEI ticket is a record used to describe an EIR relevant event. In order to provide the data required by mobile equipment management activities, the Mobile Switching Center (MSC) in the 2G mobile network shall be capable of producing IMEI tickets for each of the following events:
usage of a blacklisted IMEI, i.e. equipment is not allowed to be used;
usage of a greylisted IMEI, i.e. equipment may be used but its usage is tracked;
usage of an IMEI not found on the white list, i.e. equipment may be used.

An observed IMEI ticket is generated whenever greylisted, blacklisted or non-whitelisted mobile equipment is detected during an IMEI check. The purpose of the ticket is to link the mobile equipment under observation with its current user. The ticket also includes information describing when and where the equipment was used to enable the tracking of such equipment. Finally, if the ticket was triggered by a call attempt, a call reference is provided in order to locate the corresponding CDR.

In the packet switched domain an S-CDR is used to collect charging information related to the PDP context data information for a mobile in the Serving GPRS Support Node (SGSN). The PDP context data contains information for setting up a data connection through the mobile network. An M-CDR is used to collect charging information related to the mobility management of a mobile in the SGSN.

In the so-called IMS charging architecture if the called party requests additional media components (e.g. voice, video) with regard to the initial request from calling party, then called party can—depending on operational conditions of the service—be charged for these additional components. THE IMS charging architecture shall allow the operator to charge per media component. A session, i.e. a logical connection between parties involved in a packet switched based communication, may comprise a number of media components. It shall be possible to correlate the charging data of the different media components belonging to a session. For a session comprising several media components (such as audio and video), charging data is generated for each media component and needs to be correlated between network elements. For this, a component identifier is unique and clearly identifies to which media flow of a session this charging information belongs to.

3GPP TS 32.200 does not prevent customer from misusing services like in the examples above. Nor does it enable measure to charge customers for the actual used services in case of misuse.

EP1381203A1 discloses a method and a system for managing provision of data managed by an external network to a terminal and associated intermediate equipment. Content and push servers are connected through an external network such as the internet, an intermediate equipment, a mobile system and switched telecommunication network to mobile and fixed terminals. Server data is defined in domains which are used in service sessions under the control of the intermediate equipment which is linked to a billing facility. The method and system are used to manage the supply of data from servers on an internet type network to mobile and fixed terminals and provide a dialogue facility between terminal operators and the providers of server contents and relates billing to service sessions with known times and data volumes.

EP1381203A1 does not prevent customer from misusing services like in the examples above. Nor does it enable measure to charge customers for the actual used services in case of misuse.

### PROBLEM DEFINITION

The prior art does not provide a solution to prevent customers from misusing of telecommunication services and to enable measures to charge customers for actual used services in case of misuse.

### AIM OF THE INVENTION

The aim of the invention is to prevent misuse of telecommunication services and enable measures to charge customers for actual used services in case of misuse. A further aim of the invention is to provide a solution to offer personalized content services.

### SUMMARY

The present invention provides a solution to prevent customers from misusing of telecommunication services and to enable measures to charge customers for actual used services in case of misuse. The present invention also provides a solution to offer personalized content services.

According to a first aspect of the invention, a method is provided for determining a service tariff class. The service tariff class identifies the tariff for usage of a telecommunication service on a user equipment. The method can comprise the step of receiving in a network component a user identity. The network component can be part of a mobile packet switched network. The user identity identifies a user of the user equipment. The user identity can be an identity that is stored on a SIM Card. The method can comprise the step of receiving in the network component an equipment identity. The equipment identity identifies the user equipment. The equipment identity can be an IMEI identity that is stored on the user equipment. The method can comprise the step of correlating in the network component the user identity with the equipment identity. The method can comprise the step of setting the service tariff class based on the outcome of the correlating step. This advantageously can allow the user to continue to use the user equipment even when there is no match between user identity and equipment identity, in which case the user can be charged with a different tariff. The method can comprise the step of storing the outcome of the correlating step in a first database. Alternatively the method can comprise the step of storing the service tariff class that is based on the outcome of the correlating step in the first database. This advantageously makes it possible to use the outcome of the correlation at a later moment. The method can comprise the step of receiving in the network component a first service type. The first service type identifies an actual used service on the user equipment. The method can comprise the step of matching the first service type with a second service type. The second service type identifies an agreed service for the user equipment. The method can comprise the step of changing the service tariff class based on the outcome of the matching step. This advantageously can allow the user to continue to use the actual used service on the user equipment even when there is no match between the actual used service and the agreed service, in which case the user can be charged with a different tariff. The method can comprise the step of storing information about a usage of the telecommunication service in the first database. The method can comprise the step of correlating the stored information with information from a second database, which second database comprises information about a service offer. This advantageously makes it possible to determine which service offer could be of interest to the user. The method can comprise the step of sending a service offer message to the user equipment based on the outcome of this correlating step.

According to a second aspect of the invention, a telecommunication system is provided. The telecommunication system can comprise a mobile packet switched network. The telecommunication system can comprise a user equipment and a network component. The user equipment is linked to the network component. The network component can comprise means for receiving a user identity. The user identity identifies a user of the user equipment. The user identity can be an identity that is stored on a SIM Card. The network component can comprise means for receiving an equipment identity. The equipment identity identifies the user equipment. The equipment identity can be an IMEI identity that is stored on the user equipment. The network component can comprise means for correlating the user identity with the equipment identity. The network component can comprise means for setting a service tariff class based on the outcome of the correlation, wherein the service tariff class identifies the tariff for usage of a telecommunication service on the user equipment. This advantageously can allow the user to continue to use the user equipment even when there is no match between user identity and equipment identity, in which case the user can be charged with a different tariff. The telecommunication system can comprise a first database. The network component can comprise means for storing the outcome of the correlation in the first database. The network component can alternatively comprise means for storing the service tariff class that is based on the outcome of the correlation in the first database. This advantageously makes it possible to use the outcome of the correlation at a later moment. The network component can comprise means for receiving a first service type. The first service type identifies an actual used service on the user equipment. The network component can comprise means for matching the first service type with a second service type. The second service type identifies an agreed service for the user equipment. The network component can comprise means for changing the service tariff class based on the outcome of the matching. This advantageously can allow the user to continue to use the actual used service on the user equipment even when there is no match between the actual used service and the agreed service, in which case the user can be charged with a different tariff. The network component can comprise means for storing information about a usage of the telecommunication service in the first database. The telecommunication system can comprise a second database. The second database comprises information about a service offer. The network component can comprise means for correlating the stored information with information from the second database. This advantageously makes it possible to determine which service offer could be of interest to the user. The network component can comprise means for sending a service offer message to the user equipment based on the outcome of this correlation.

According to a third aspect of the invention, a network component is provided for determining a service tariff class. The network component is as provided in the telecommunication system.

### BRIEF DESCRIPTION OF THE DRAWINGS

The invention will be explained in greater detail by reference to exemplary embodiments shown in the drawings, in which:

FIG. 1 shows an exemplary embodiment of a telecommunication system and a network component according to the invention;

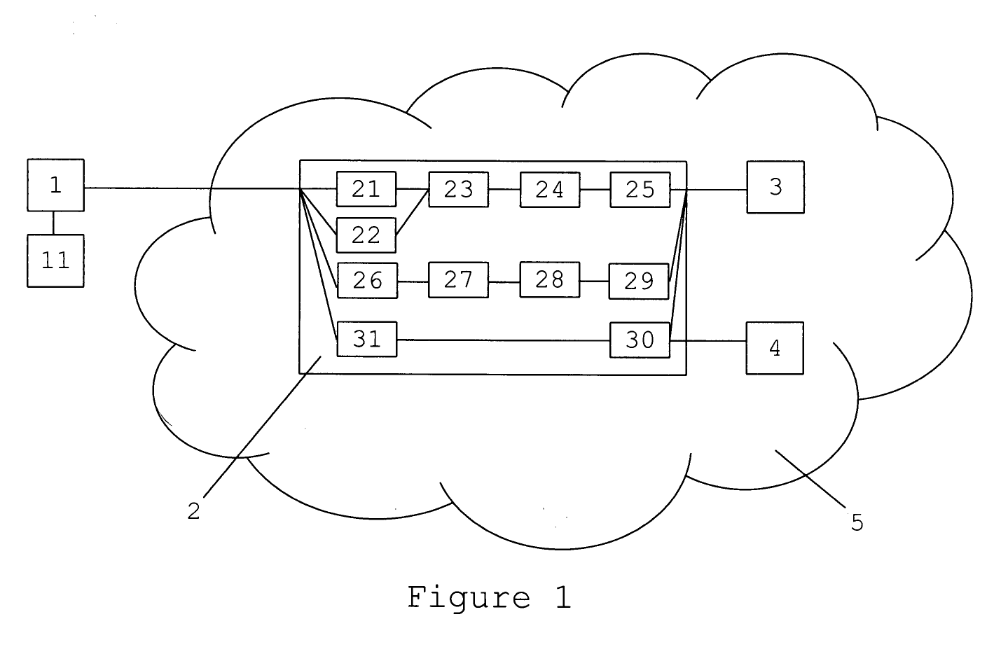

FIG. 2 shows an exemplary embodiment of a method according to the invention.

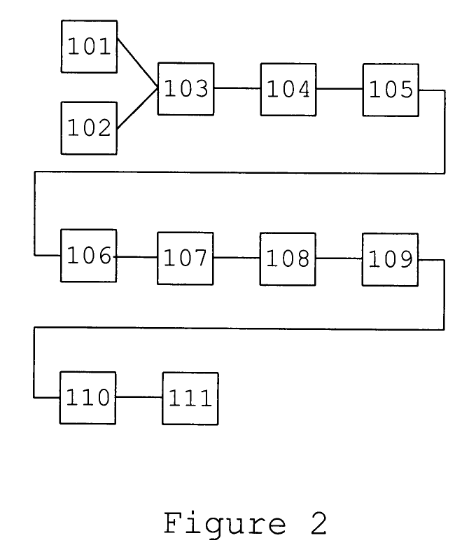

### DETAILED DESCRIPTION

For the purpose of teaching of the invention, preferred embodiments of the invention are described in the sequel. It will be apparent to the person skilled in the art that other alternative and equivalent embodiments of the invention can be conceived and reduced to practice without departing from the true spirit of the invention, the scope of the invention being only limited by the claims as finally granted.

The invention provides a solution to prevent misuse of telecommunication services and enables measures to charge customers for actual used services in case of misuse.

The network checks the correct correlation between the SIM Card, or any other hardware or software providing the user identity, and the user equipment based on the IMEI, or any other hardware or software providing the equipment identity and then store the correlated information into a database. Examples of network components in a mobile packet switched network that can perform the correlation check are a serving GPRS support node (SGSN), a gateway GPRS support node (GGSN), or a signal transfer point (STP).

In a first step a certain tariff bundle may restrict the usage of a certain SIM Card to a certain user equipment (1:1) or restrict the usage of a certain SIM Card to one or more user equipment (1:n). If in these two cases the correlation of the SIM Card to the user equipment fails, the user can continue to use the equipment, but will be charged on a different tariff class, e.g. a higher tariff or a lower tariff.

In a second step it is to be checked if the actual used service matches the charged service. In case the actual used service is identified by the network as a service type which falls into a different tariff class than the currently connected tariff class with the original service type, the tariff class is changed to the actual used service. In case the actual used service is identified by the network as the service type which has been agreed upon during the call set-up, the tariff class is not changed. The result of this is that the user can continue to use the service (e.g. VoIP telephony), even if it is misusing another service with a lower tariff (e.g. normal internet browsing). In the example the use of VoIP is detected and the user will be charged for VoIP usage although the user started with normal internet browsing.

The invention also provides a solution to offer personalized content services to a customer based on the end-device used by the customer and on an analysis of services-generated traffic to and/or from the customer.

With the user equipment and service usage known, the subscriber can be offered additional content services based on (i) the end-device used by the subscriber and on (ii) an in-deep analysis of the originated and terminated traffic stream of the subscriber.

The following information can be stored in a central or de-central database:
subscribers end-devices;
results of the in-deep analysis per subscriber;
potential service proposal and offer.

The database is e.g. created based on information send from network components in the mobile packet switched network, such as serving GPRS support node (SGSN), a gateway GPRS support node (GGSN) or IN (Intelligent Network) nodes.

In the first step, the network checks the correct correlation between the SIM Card and the user equipment based on the IMEI and stores this correlated information into a database.

In case the subscriber uses the network access and the network investigates that the correlation of the SIM Card to the user equipment fails, the user can continue to use the equipment, but will be charged on a different tariff class, e.g. a higher tariff or a lower tariff. Now the originating and terminating individual user traffic can be analyzed, possibly in real-time. Important information of the subscriber's behavior (i.e. what data is sent and/or received) is then stored in the database in order to verify if there are additional service offerings that could be of interesting to the end-user. Parameters that can be stored are for example:
Data-volume;
Visited application locations like webpages, ftp-server, SIP-Proxies;
Time;
Source and destination addresses;
Traffic direction (uplink/downlink);
QoS (Quality of Service) used by the subscriber;
Roaming location;
Other information of interest for additional service offer.

This information serves as an input for a correlation to determine which service offer could be of interest to the customer. The resulting service offer for the subscriber could be for example a proposal for a ringtone, proposals for download, a proposed content server with individual links, interesting sport-news, actual news, a television program proposal, VoIP provider offers, advertisement, etcetera.

Content service offerings are generated based on a general reference service-offer database that could be centralized for all subscribers. This service-reference database is stored in a database of the network operator with predefined interfaces for the transfer of potential proposals of the mobile operators content partner.

The user equipment of the customer receives the personalized content service proposals via speech, SMS, MMS, WAP, GPRS, or any other communication mechanism.

An example of behavior that can be detected from analyzing a traffic stream is a user browsing sport news on the internet often. Based on the analysis, as a personalized content service offer the user can receive a proposal for a sports newsletter subscription.

1: A method for determining a service tariff class, the service tariff class identifying the tariff for usage of a telecommunication service on a user equipment, the method comprising the steps of:
receiving in a network component a user identity, the user identity identifying a user of the user equipment;
receiving in the network component an equipment identity, the equipment identity identifying the user equipment;
correlating in the network component the user identity with the equipment identity;
setting the service tariff class based on the outcome of the correlating step.

2: The method according to claim 1, the method further comprising the step of storing the outcome of the correlating step in a first database.

3: The method according to claim 1, the method further comprising the step of storing the service tariff class that is based on the outcome of the correlating step in a first database.

4: The method according to claim 1, in which the user identity is an identity that is stored on a SIM Card.

5: The method according to claim 1, in which the equipment identity is an IMEI identity that is stored on the user equipment.

6: The method according to claim 1, in which the network component is part of a mobile packet switched network.

7: The method according to claim 1, the method further comprising the steps of:
receiving in the network component a first service type, the first service type identifying an actual used service on the user equipment;
matching the first service type with a second service type, the second service type identifying an agreed service for the user equipment;
changing the service tariff class based on the outcome of the matching step.

8: The method according to claim 2, the method further comprising the step of:
storing information about a usage of the telecommunication service in the first database.

9: The method according to claim 8, the method further comprising the steps of:
correlating the stored information with information from a second database, the second database comprising information about a service offer;
sending a service offer message to the user equipment based on the outcome of this correlating step.

10: A telecommunication system comprising a user equipment and a network component, the user equipment being linked to the network component, in which the network component comprises:
means for receiving a user identity, the user identity identifying a user of the user equipment;
means for receiving an equipment identity, the equipment identity identifying the user equipment;
means for correlating the user identity with the equipment identity;
means for setting a service tariff class based on the outcome of the correlation, the service tariff class identifying the tariff for usage of a telecommunication service on the user equipment.

11: The telecommunication system according to claim 10, the telecommunication system further comprising a first database, in which the network component further comprises:
means for storing the outcome of the correlation in the first database.

12: The telecommunication system according to claim 10, the telecommunication system further comprising a first database, in which the network component further comprises:
means for storing the service tariff class that is based on the outcome of the correlation in the first database.

13: The telecommunication system according to claim 10, in which the user identity is an identity that is stored on a SIM Card.

14: The telecommunication system according to claim 10, in which the equipment identity is an IMEI identity that is stored on the user equipment.

15: The telecommunication system according to claim 10, in which the telecommunication system comprises a mobile packet switched network.

16: The telecommunication system according to claim 10, in which the network component further comprises:
means for receiving a first service type, the first service type identifying an actual used service on the user equipment;
means for matching the first service type with a second service type, the second service type identifying an agreed service for the user equipment;
means for changing the service tariff class based on the outcome of the matching.

17: The telecommunication system according to claim 11, in which the network component further comprises:
means for storing information about a usage of the telecommunication service in the first database.

18: The telecommunication system according to claim 17, the telecommunication system further comprising a second database, the second database comprising information about a service offer, in which the network component further comprises:
means for correlating the stored information with information from the second database;
means for sending a service offer message to the user equipment based on the outcome of this correlation.

19: A network component for determining a service tariff class, the service tariff class identifying the tariff for usage of a telecommunication service on a user equipment, in which the network component comprises:
means for receiving a user identity, the user identity identifying a user of the user equipment;
means for receiving an equipment identity, the equipment identity identifying the user equipment;
means for correlating the user identity with the equipment identity;
means for setting a service tariff class based on the outcome of the correlation, the service tariff class being the tariff for usage of a telecommunication service on the user equipment.

20: The network component according to claim 19, in which the network component further comprises:
means for storing the outcome of the correlation in a first database.

21: The network component according to claim 19, in which the network component further comprises:
means for storing the service tariff class that is based on the outcome of the correlation in the first database.

22: The network component according to claim 19, in which the network component is part of a mobile packet switched network.

23: The network component according to claim 19, in which the network component further comprises:
means for receiving a first service type, the first service type identifying an actual used service on the user equipment;
means for matching the first service type with a second service type, the second service type identifying an agreed service for the user equipment;
means for changing the service tariff class based on the outcome of the matching.

24: The network component according to claim 20, in which the network component further comprises:
means for storing information about a usage of the telecommunication service in the first database.

25: The network component according to claim 24, in which the network component further comprises:
means for correlating the stored information with information from a second database, the second database comprising information about a service offer;
means for sending a service offer message to the user equipment based on the outcome of this correlation.
